(19) United States
(12) Patent Application Publication
(10) Pub. No.: US 2008/0016650 A1
(43) Pub. Date: Jan. 24, 2008

(54) Display rotation apparatus

(75) Inventors: Yang-Ho Moon, Ansan-si (KR); Chil-Sung Lee, Suwon-si (KR); Jae-Kyung Kim, Ansan-si (KR); Kyoung-Shin Park, Suwon-si (KR); Dong-Won Choi, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/826,008

(22) Filed: Jul. 11, 2007

(30) Foreign Application Priority Data
Jul. 12, 2006 (KR) 10-2006-0065390

(51) Int. Cl. E05D 11/10

(52) U.S. Cl. 16/334

(57) ABSTRACT

A display rotation apparatus are disclosed. A display rotation apparatus that includes a fixed body, a first arm whose one end is coupled to the fixed body by interposing a first hinge member, a second arm whose one end is coupled to the other end of the first arm by interposing a second hinge member, a movable body coupled to the second arm, a first motor part coupled to the first hinge, and a second motor part coupled to the second hinge. This display rotation apparatus is movable (rotating and extending) automatically. And the durability of the display rotation apparatus increases by using the clutch part while manual moving.

### CROSS-REFERENCE TO RELATED APPLICATIONS

This application claims the benefit of Korean Patent Application No. 10-2006-0065390 filed with the Korean Intellectual Property Office on Jul. 12, 2006, the disclosure of which is incorporated herein by reference in its entirety.

### BACKGROUND

1. Technical Field

The present invention relates to a display rotation apparatus.

2. Description of the Related Art

Flat panel displays, such as TV's or monitors employing LCD's, PDP's, LED's, etc., provide the benefit of allowing efficient use of spaces, and are fast replacing Braun tube TV's and monitors. The increase in demand for such flat panel displays is expected to continue into the future. In particular, flat panel LCD or PDP TV's, often referred to as “wall-mount TV's,” are fixedly attached to wall surfaces for use. When viewing a wall-mount TV thus fixed, the largest viewing angle is achieved directly in front of the TV.

However, when the TV is fixed to a wall surface, the position that allows the largest viewing angle of the TV screen is also fixed, and as a viewer changes position, adequate viewing may not be obtained. It is difficult to modify the TV's position with the conventional wall-mount TV, because there is little or no distance between the TV and the wall, and even if the TV is spaced from the wall surface by means of additional members, it is not possible to rotate the TV to a desired orientation. Also, attempting to resolve such problems using an apparatus to maintain a certain distance may result in another problem of degrading the elegant appearance and the efficiency in utilizing an indoor space, which are important benefits of wall-mount TV's.

### SUMMARY

An aspect of the invention is to provide a display rotation apparatus which protrudes from a fixed body such as a wall, and which allows automatic and manual rotation in every direction.

One aspect of the invention provides a display rotation apparatus that includes a fixed body, a first arm whose one end is coupled to the fixed body by interposing a first hinge member, a second arm whose one end is coupled to the other end of the first arm by interposing a second hinge member, a movable body coupled to the second arm, a first motor part coupled to the first hinge, and a second motor part coupled to the second hinge.

The motor parts respectively include a driving part generating rotation force by the rotation of a motor, a rotation part transferring the rotation force to the outside. The rotation part also includes a driving axis obtaining the rotation force from the motor, a driven axis rotatably coupled to the driving axis, and a clutch part interposed between the driving axis and the driven axis.

The movable body may be coupled to the second arm by interposing a third hinge member, and the third hinge member may be coupled to a third motor part.

The display rotation apparatus includes an elastic body coupled between the movable body and the second arm to offset the gravitational moment of the movable body.

The display rotation apparatus includes a distance measuring sensor coupled to the movable body.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a side elevational view of a display rotation apparatus according to a first disclosed embodiment of the invention.

FIG. 2 is a backside elevational view of a display rotation apparatus according to a first disclosed embodiment of the invention.

FIG. 3 is a side view of a first motor part according to a second disclosed embodiment of the invention.

FIG. 4 is a cross sectional view of a rotation part of the first motor part according to a second disclosed embodiment of the invention.

FIG. 5 is a side elevational view of a display rotation apparatus according to a third disclosed embodiment of the invention.

### DETAILED DESCRIPTION

Embodiments of the display rotation apparatus according to certain aspects of the invention will be described below in more detail with reference to the accompanying drawings. In the description with reference to the accompanying drawings, those components are rendered the same reference number that are the same or are in correspondence regardless of the figure number, and redundant explanations are omitted. Also, the basic principles will first be described before discussing the preferred embodiments of the invention.

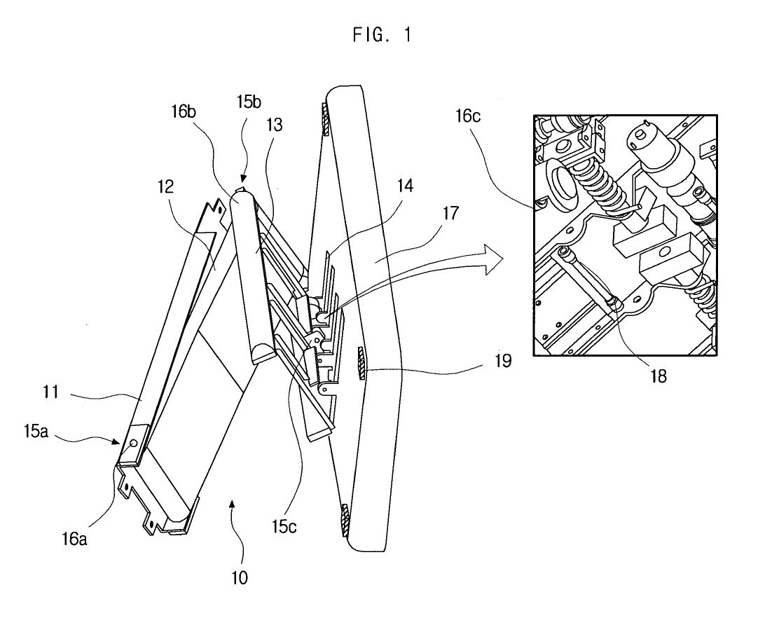

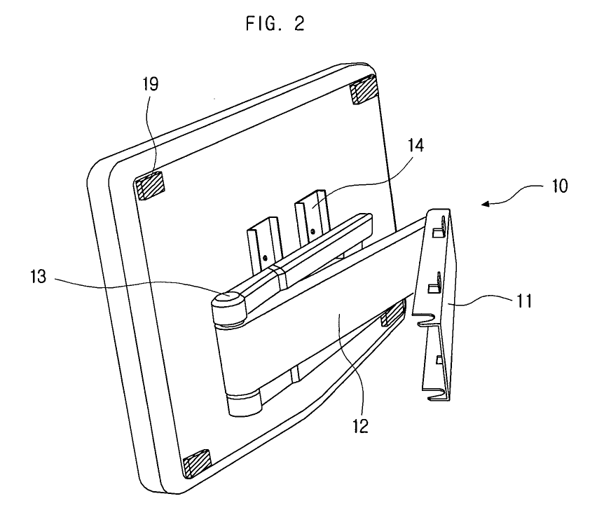

FIG. 1 is a side elevational view of a display rotation apparatus according to a first disclosed embodiment of the invention, and FIG. 2 is a backside elevational view of a display rotation apparatus according to a first disclosed embodiment of the invention. In FIG. 1, 2 are illustrated a display rotation apparatus 10, a fixed body 11, a first arm 12, a second arm 13, a movable body 14, a first hinge member 15a, a second hinge member 15b, a third hinge member 15c, a first motor part 16a, a second motor part 16b, a third motor part 16c a display 17, an elastic body 18, a distance measuring sensor 19.

In this embodiment, the display rotation apparatus 10 consists of the two arms (12, 13) and the fixed body 11 combined in a Z form. The first hinge member 15a is interposed between the fixed body 11 and the first arm 12. And the second hinge member 15b is interposed between the first arm 12 and the second arm 13. And the third hinge member 15c is interposed between the second arm 13 and the movable body 17.

Meanwhile, the rotating axis of the first hinge member 15a is parallel with the rotating axis of the second hinge member 15b. the rotating axis of the third hinge member 15c is perpendicular with rotating axises of the first and second hinge members (15a, 15b). Therefore, when the arms (12, 13) are moving, the movable body 14 moves not only backwards and forwards but also sideways. The movable body 14 also moves back and forth using the third hinge member 15c as a pivot.

Motor parts 16a and 16b offer driving force to arms 12 and 13 respectively to move the movable body 14 sideways. Through these motor parts (16a, 16b, and 16c), display 17 can move back and forth, backwards and forwards, and sideways from the fixed body 11.

These motor parts (16a, 16b, 16c) are controlled by a controller so that a viewer is able to move the display to a certain direction.

In FIG. 1, the display 17 is coupled to the distance measuring sensor 19. The distance measuring sensor 19 senses the distance between the display 17 and the fixed body 11, or the wall in real-time. And the distance measuring sensor 19 transfers the distance information to the controller. The controller prevents the display 17 from collision with wall by controlling the motor parts (16a, 16b, 16c). Meanwhile, the distance measuring sensor 19 may be coupled to the movable body 14.

Meanwhile, the display rotation apparatus 10 can be moved manually. In this time, the motors of the motor parts (16a, 16b, 16c) would be damaged by compulsory rotation. Compulsory rotation also make noises.

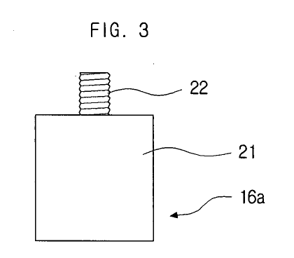

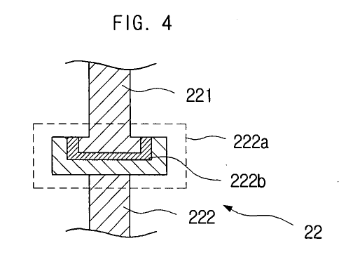

FIG. 3 is a side view of a first motor part according to a second disclosed embodiment of the invention, FIG. 4 is a cross sectional view of a rotation part of the first motor part according to a second disclosed embodiment of the invention. In FIG. 3, 4 are illustrated a first motor part 16a, a driving part 21, a rotation part 22, a clutch part 222a, a driving axis 222, a driven axis 221. The first motor part 16a is coupled to the first hinge member 15a in FIG. 3. Other motor parts (16b, 16c) are also respectively coupled to hinge members (15b, 15c) as shown in FIG. 3.

In FIG. 3, the first motor part 16a consists of the driving part 21 and the rotation part 22. The driving part 2 has a motor, and the rotation part 22 serves as an axis that transfers the driving force of the motor to the next component. The driving part 21 and the rotation part 22 shown in FIG. 3 couple with the fixed body 11 and the first arm 12, respectively, at the first hinge member 15a shown in FIG. 1. Consequently, the first arm 12 of FIG. 1 stretches back and forth when the first motor part 16a is running.

Meanwhile, as shown FIG. 4, the rotation part 22 consists of the driving axis 22 coupled the rotation axis of the motor, the clutch part 222a coupled to the driving axis 222 and the driven axis 221 having the driving force while contacting the clutch part 222a. The clutch part 222a is a part controlling the friction that couples to the driving axis 222 as one body or devided body as shown FIG. 4. The clutch part 222a is able to couple to not only the driving axis 222 but also the driven axis 221. The washer 222b is interposed between the clutch part 222a and the driven axis 221 to maintain constant friction.

As for the operation of the rotation part 22, the driven axis 221 does not slip with the clutch part 222a while the motor runs because the driving force of the motor is smaller than the friction of the clutch 222a. But, the driven axis 221 slip with the clutch part 222a while the outside force rotates compulsory the driven axis 221 because the friction force of the clutch part 222a is smaller than cogging torque of the motor. The cogging torque means the force that is necessary during the compulsory rotation by the outside force. In this way, we can decrease the damage of the motor by compulsory rotation if the friction of the clutch part 222a is smaller than the cogging torque of the motor. The washer 222b may be interposed between the clutch part 222a and driven axis 221 to control the friction.

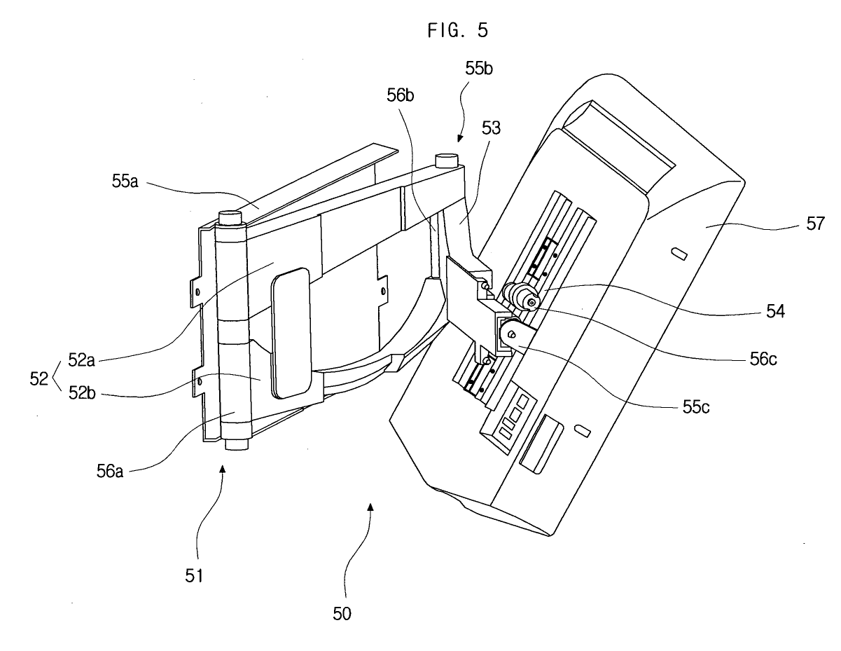

FIG. 5 is a side elevational view of a display rotation apparatus according to a third disclosed embodiment of the invention, In FIG. 5 is illustrated, a display rotation apparatus 50, a fixed body 51, a first arm 52, a second arm 53, a movable body 54, a first hinge member 55a, a second hinge member 55b, a third hinge member 55c, a first motor part 56a, a second motor part 56b, a third motor part 56c, a display 57.

In this embodiment, the first arm 52 consists of two link members (52a, 52b), these link members (52a, 52b) couple to the fixed body 51 with respectively interposing the first hinge member 55a. The gravitational moment of the display 57 is biggest at the first hinge member 55a. In accordance with, the first arm 52 and the first hinge member 55a supporting the first arm 52 must have strength to guarantee the reliability of the display rotation apparatus. In this embodiment, the first hinge member 55a is formed as big size as to guarantee strength. Meanwhile, the first link member 52a couples to the other end of the second link member 52b by interposing the second arm 53 and the second hinge member 55b. Moreover, a space exits between the first link member 52a and the second link member 52b. The second arm 53 would be interposed when the second arm 53 is contracted. In accordance with, the display rotation apparatus 50 would be the smallest space when the display is contracted.

According to certain embodiments of the invention as set forth above, the display rotation apparatus can extend the display from the fixed body to obtain moving space. the display rotation apparatus is movable(rotating and extending) automatically. And the durability of the display rotation increases by using the clutch part while manual moving.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A display rotation apparatus comprising:
a fixed body;
a first arm whose one end of the first arm coupled to the fixed body by interposing a first hinge member;
a second arm whose one end of the second arm coupled to the other end of the first arm by interposing a second hinge member;
a movable body coupled to the second arm;
a first motor part coupled to the first hinge; and
a second motor part coupled to the second hinge.

2. The display rotation apparatus of claim 1, wherein the movable body coupled to the
second arm by interposing a third hinge member, said third hinge member coupled to a third motor part.

3. The display rotation apparatus of claim 1, wherein an elastic body is coupled between the movable body and the second arm to offset the gravitational moment of the movable body.

4. The display rotation apparatus of claim 1, wherein a distance measuring sensor is coupled to the movable body.

5. The display rotation apparatus of claim 1, wherein the motor parts respectively comprising,
a driving part generating rotation force by the rotation of a motor; and
a rotation part transferring the rotation force to the outside,
said rotation part comprising,
a driving axis obtaining the rotation force from the motor;
a driven axis rotatably coupled to the driving axis; and
a clutch part interposed between the driving axis and the driven axis.
